(19) United States
(12) Patent Application Publication
(10) Pub. No.: US 2026/0095538 A1
(43) Pub. Date: Apr. 2, 2026

(54) METHOD OF GENERATING DOT DATA AND PRINTING APPARATUS

(71) Applicant: SEIKO EPSON CORPORATION, Tokyo (JP)

(72) Inventors: Gakuji YAMAMOTO, Shiojiri-shi (JP); Gen IMAI, Shiojiri-shi (JP)

(21) Appl. No.: 19/341,397

(22) Filed: Sep. 26, 2025

(30) Foreign Application Priority Data
Sep. 30, 2024 (JP) 2024-170140

(51) Int. Cl. H04N 1/409; B41J 2/21; H04N 1/405

(52) U.S. Cl. CPC H04N 1/4092; B41J 2/2121; B41J 2/2132; H04N 1/4057

(57) ABSTRACT

A method of generating dot data representing positions of dots formed of ink from a print head includes a first detection step of detecting, as a first processing target edge portion, at least one of a first edge portion located at one side in a first direction in an area darker than a surrounding area and a second edge portion located at one side in a second direction crossing the first direction in an area darker than a surrounding area out of edges existing in a detection target area in at least a part of an image having a plurality of pixels arranged in the first direction and the second direction, and a generation step of generating the dot data from the image such that an amount of the ink ejected from the print head to the first processing target edge portion is reduced.

The present application is based on, and claims priority from JP Application Serial Number 2024-170140, filed Sep. 30, 2024, the disclosure of which is hereby incorporated by reference herein in its entirety.

### BACKGROUND

### 1 . Technical Field

The present disclosure relates to a method of generating dot data representing positions of dots to be formed by ink from a print head, and a printing apparatus.

### 2. Related Art

As a printing apparatus, an inkjet printer that forms a print image by ejecting ink droplets from a print head to a print medium is known. Since the ink droplet is a liquid, an edge portion of an area darker than a surrounding area such as a character or a bar code may bleed on the print medium to thereby deteriorate printing quality in some cases. In order to prevent such deterioration of printing quality, it is conceivable to suppress the ejection of the ink over the entire edge of the dark area. In a method of generating ejection position data disclosed in JP-A-2022-81922, processing of changing a pixel value from an ejection value to a non-ejection value by one pixel at both sides of a line having a width of no smaller than three pixels is performed.

JP-A-2022-81922 is an example of the related art.

For example, when a pixel value is changed from an ejection value to a non-ejection value over the entire edge of the barcode, the barcode may become too thin to read in some cases. In the method of generating the ejection position data described above, it is not considered that it becomes impossible to read the barcode. In addition, when the processing described above is performed when the thin line corresponds to three pixels, the width of the line is decreased to only one pixel, and therefore, deterioration of an object including the thin line such as a small character is conspicuous.

### SUMMARY

A method of generating dot data according to the present disclosure is a method of generating dot data representing positions of dots formed of ink from a print head, the method including:
a first detection step of detecting, as a first processing target edge portion, at least one of a first edge portion located at one side in a first direction in an area darker than a surrounding area and a second edge portion located at one side in a second direction crossing the first direction in an area darker than a surrounding area out of edges existing in a detection target area in at least a part of an image having a plurality of pixels arranged in the first direction and the second direction; and
a generation step of generating the dot data from the image such that an amount of the ink ejected from the print head to the first processing target edge portion is reduced.

Further, a printing apparatus according to the present disclosure is a printing apparatus configured to form a print image on a print medium with ink, the apparatus including:
a print head configured to eject the ink; and a control unit configured to control ejection of the ink from the print head to the print medium such that dots constituting the print image are formed on the print medium, wherein
the control unit is configured to perform
first detection processing of detecting, as a first processing target edge portion, at least one of a first edge portion located at one side in a first direction in an area darker than a surrounding area and a second edge portion located at one side in a second direction crossing the first direction in an area darker than a surrounding area out of edges existing in a detection target area in at least a part of an image having a plurality of pixels arranged in the first direction and the second direction, and
ejection control processing of controlling ejection of the ink from the print head to the print medium such that an amount of the ink to be ejected to the first processing target edge portion is reduced.

### BRIEF DESCRIPTION OF THE DRAWINGS

FIG. 1 is a diagram schematically showing a configuration example of a printing apparatus.

FIG. 2 is a diagram schematically showing an example of a nozzle surface of a print head.

FIG. 3 is a flowchart schematically showing an example of print control processing.

FIG. 4 is a diagram schematically showing an example of forming a print image in which the ink amount in a first processing target edge portion is reduced from the input image.

FIG. 5 is a diagram schematically showing an example of generating dot data in which the ink amount in a second processing target edge portion is reduced from an extracted image.

FIG. 6A is a diagram schematically showing an example of an edge detection processing designation screen, FIG. 6B is a diagram schematically showing an example of a medium type designation screen, and FIG. 6C is a diagram schematically showing an example of a dark area designation screen.

FIG. 7A is a diagram schematically showing an example of an edge width designation screen, and FIG. 7B is a diagram schematically showing an example of a reference pattern of 5×5 pixels.

FIG. 8A is a diagram schematically showing an example of an object designation screen, and FIG. 8B is a diagram schematically showing an example of a detection target area contained in an image.

FIG. 9 is a diagram schematically showing a comparative example of forming a print image from an input image.

### DESCRIPTION OF EMBODIMENTS

An embodiment of the present disclosure will hereinafter be described. Obviously, the following embodiment is nothing more than exemplifying the present disclosure, and all the features shown in the embodiment are not necessarily essential to the solution disclosed herein.

### (1) Overview of Aspects Included in Present Disclosure

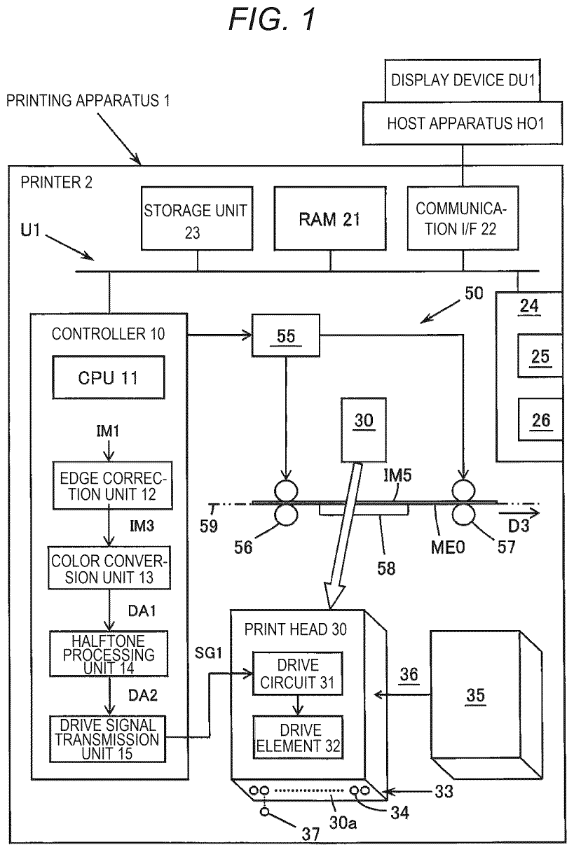

An overview of aspects included in the present disclosure will first be described with reference to examples shown in FIGS. 1 to 9. Note that the drawings of the present application are diagrams schematically illustrating the examples, and in order to make each portion of these drawings have a recognizable size, the scale of each portion may be different from the actual scale in some cases, the enlargement ratio may be different between directions illustrated in these drawings in some cases, and the drawings may not be consistent with each other in some cases. Obviously, each element in the present aspects is not limited to a specific example denoted by the reference symbol. In “Overview of Aspects Included in Present Disclosure”, a description in parentheses means supplementary description of the term immediately before the parentheses.

Further, in the present application, a numerical range “Min to Max” means a range no less than a minimum value Min and no more than a maximum value Max.

### Aspect 1

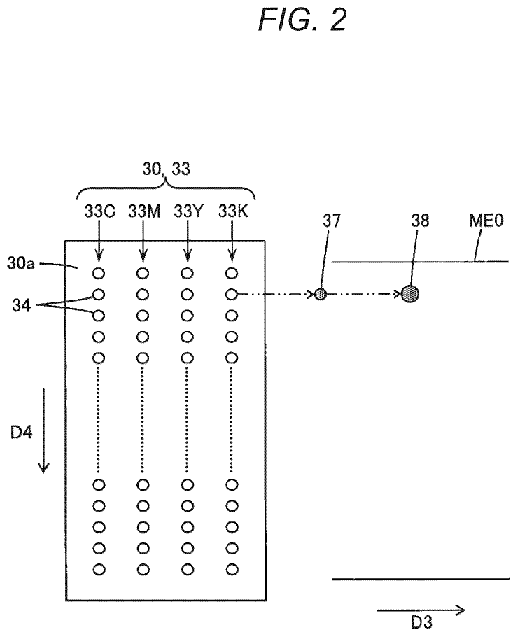

As illustrated in FIGS. 2 to 4, a method of generating dot data according to an aspect is a dot data generation method that generates dot data DA2 representing positions of dots 38 to be formed with ink 36 from a print head 30, and includes the following steps.

(a1) A first detection step ST1 of detecting, as a first processing target edge portion E1, at least one of a first edge portion E11 located at one side in an area (e.g., a dark area AR3) darker than surrounding area (e.g., a surrounding area AR2) in a first direction D1 and a second edge portion E12 located at one side in an area (AR3) darker than a surrounding area (AR2) in a second direction D2 crossing the first direction D1 out of edges E0 existing in a detection target area AR1 as at least a part of an image IM1 including a plurality of pixels PX0 arranged in the first direction D1 and the second direction D2.

(a2) A generation step ST3 of generating the dot data DA2 from the image IM1 such that an amount of the ink 36 to be ejected from the print head 30 to the first processing target edge portion E1 is reduced.

Accordingly, the amount of the ink 36 ejected not to the entire edges E0 existing in the detection target area AR1, but to at least one of the first edge portion E11 located at one side in the first direction D1 of the area (AR3) darker than the surrounding area (AR2) and the second edge portion E12 located at one side in the second direction D2 of the area (AR3) darker than the surrounding area (AR2), is reduced. Accordingly, it becomes possible to avoid the disadvantage that an object such as a barcode or a fine character becomes too thin while obtaining an effect of suppressing the degradation of the printing quality due to the bleeding of the ink 36. Therefore, according to the aspect described above, it is possible to provide the method of generating the dot data capable of suppressing the degradation of the printing quality due to the bleeding of the ink while suppressing deterioration of thin lines due to the fact that the ink is not ejected over the entire edge.

Various examples are conceivable as the aspect described above.

The size of the dot may be changeable. Therefore, the dot data may be binary data representing the presence or absence of dot formation, or may be multi-valued data of three or more values representing the dot formation state.

The detection target area may be the whole of an image or a part of the image.

For example, when the first direction is a left-right direction, it does not mean that the first edge portion exists at both the left and right sides in the area darker than a surrounding area, but means that the first edge portion exists at the left side or the right side of the area darker than a surrounding area. When the second direction is an up-down direction, it does not mean that the second edge portion exists at both the upper and lower sides in the area darker than a surrounding area, but means that the first edge portion exists at the upper side or the lower side of the area darker than a surrounding area. Obviously, the first direction may be the up-down direction, and the second direction may be the left-right direction.

The decrease in the amount of ink to be ejected to the first processing target edge portion includes that the ink is not ejected to the first processing target edge portion.

In the present application, “first”, “second”, and so on are terms used to identify a plurality of elements having similarities, and do not mean the order.

Obviously, the additional remarks described above also apply to the following aspects.

### Aspect 2

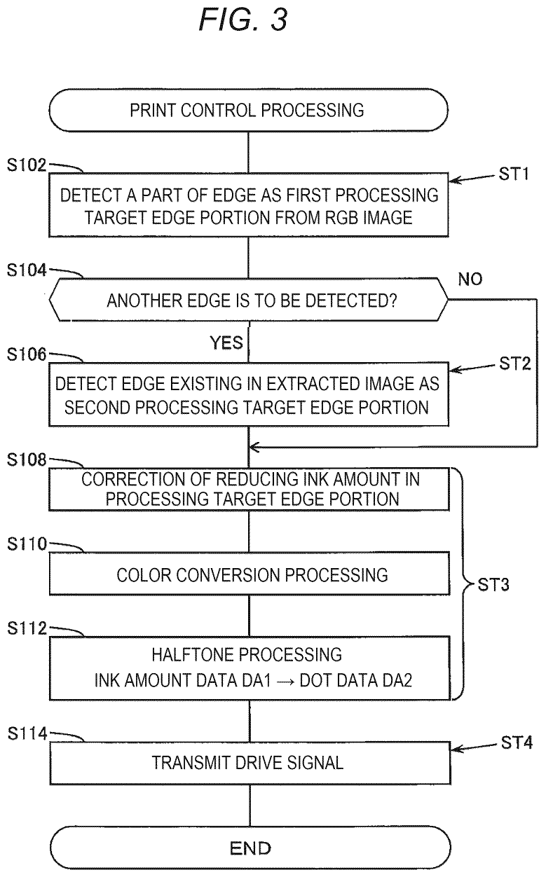

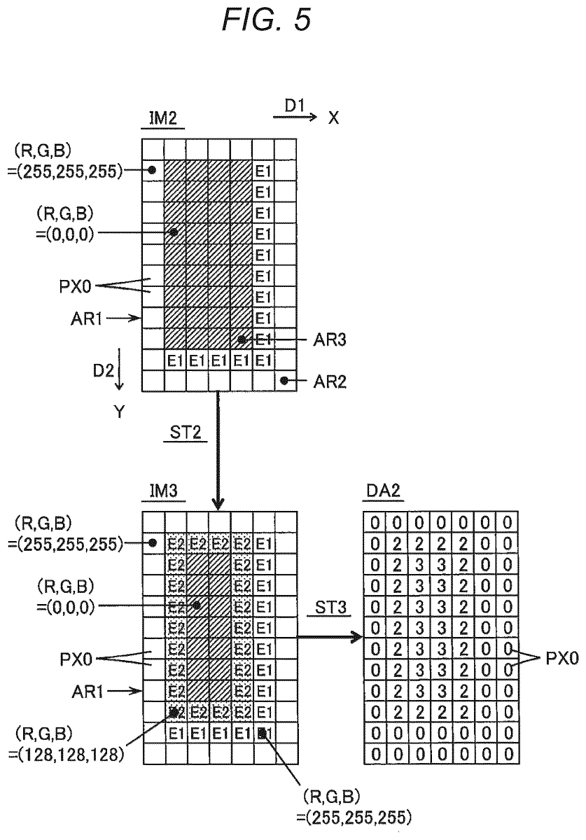

As illustrated in FIGS. 3 and 5, the present method of generating the dot data may further include the following step.

(a3) A second detection step ST2 of detecting, as a second processing target edge portion E2, at least a part of an edge existing in an extracted image IM2 representing a portion other than the first processing target edge portion E1 in the detection target area AR1.

In the generation step ST3, the dot data DA2 may be generated from the image IM1 such that the ink 36 is not ejected from the print head 30 to the first processing target edge portion E1, the ink 36 is ejected from the print head 30 to the second processing target edge portion E2, and an amount of the ink 36 ejected from the print head 30 to the second processing target edge portion E2 is reduced.

It is conceivable that when the ink 36 having landed on the print medium ME0 is easy to bleed, the bleeding of the ink 36 becomes conspicuous even when a portion to which the ink 36 is not ejected is limited to the first processing target edge portion E1 out of the edges E0 existing in the detection target area AR1. In such a case, by reducing the amount of the ink 36 ejected to the second processing target edge portion E2 within a range in which that amount does not become 0, the bleeding of the ink 36 is suppressed. Therefore, in the aspect described above, when the ink having landed on the print medium is easy to bleed, it is possible to suppress the bleeding of the ink while leaving the thin line.

### Aspect 3

As illustrated in FIGS. 3, 5, and 6B, the present method of generating dot data may further include the following steps.

(a4) A printing step ST4 of ejecting the ink 36 from the print head 30 to the print medium ME0 based on the dot data DA2.

(a5) A medium type designation step ST5 of receiving designation of a type to be used out of a plurality of types 220 which can be used as the print medium ME0, and includes a first type 221 and a second type 222 in which the ink 36 is easier to bleed than the first type 221.

(a6) A second detection step ST2 of detecting, as the second processing target edge portion E2, an edge located in the extracted image IM2 representing a portion other than the first processing target edge portion E1 in the detection target area AR1 when the second type 222 is designated.

In the generation step ST3, when the first type 221 is designated, the dot data DA2 may be generated from the image IM1 so that the ink 36 is not ejected from the print head 30 to the first processing target edge portion E1. In addition, in the generation step ST3, when the second type 222 is designated, the dot data DA2 may be generated from the image IM1 such that the ink 36 is not ejected from the print head 30 to the first processing target edge portion E1 and the amount of the ink 36 ejected from the print head 30 to the second processing target edge portion E2 is reduced within a range in which that amount does not become 0.

When the second type 222 in which the ink 36 is easier to bleed than the first type 221 is designated as the print medium ME0 to be used, the amount of the ink 36 ejected to the second processing target edge portion E2 is reduced within a range in which that amount does not become 0, and thus it is possible to suppress the bleeding of the ink 36 while leaving a thin line. On the other hand, when the first type 221 is designated as the print medium ME0 to be used, the amount of the ink 36 ejected to the pixel PX0 that can be the second processing target edge portion E2 is maintained, and thus, the edge existing in the extracted image IM2 is clearly displayed. Therefore, in the aspect described above, it is possible to improve the image quality of the print image in accordance with the intention of the user.

### Aspect 4

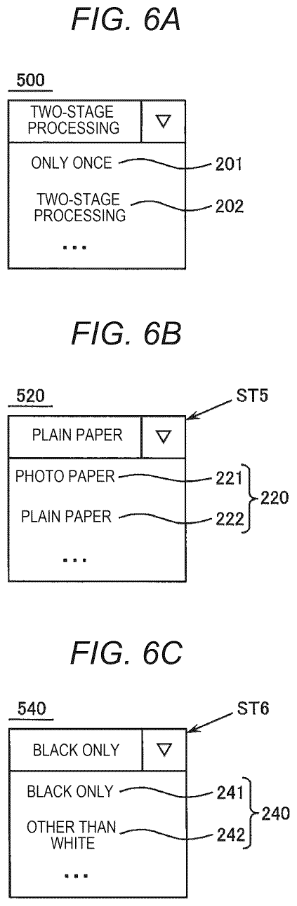

As illustrated in FIG. 6C, the present method of generating the dot data may further include the following step.

(a7) A color designation step ST6 of receiving designation of an option to be applied to the dark area (AR3) from a plurality of options 240 including a predetermined color (e.g., “BLACK ONLY” item 241) and a predetermined color range (e.g., “OTHER THAN WHITE”item 242).

In the first detection step ST1, when the predetermined color (241) is designated, at least one of the first edge portion E11 located at one side in the first direction D1 in the dark area (AR3) having the predetermined color (241) and the second edge portion E12 located at one side in the second direction D2 in the dark area (AR3) having the predetermined color (241) may be detected as the first processing target edge portion E1 out of the edges E0 existing in the detection target area AR1. Further, in the first detection step ST1, when the predetermined color range (242) is designated, at least one of the first edge portion E11 located at one side in the first direction D1 in the dark area (AR3) in the predetermined color range (242) and the second edge portion E12 located at one side in the second direction D2 in the dark area (AR3) in the predetermined color range (242) may be detected as the first processing target edge portion E1 out of the edges E0 existing in the detection target area AR1.

When an object such as a character or a barcode has the predetermined color (241) and the predetermined color (241) is designated, a high-quality print image IM5 due to the reduction of the ink amount in the first processing target edge portion E1 can be obtained with respect to the object having the predetermined color (241). When an object is within the predetermined color range (242) and the predetermined color range (242) is designated, the high-quality print image IM5 due to the reduction of the amount of the ink in the first processing target edge portion E1 can be obtained with respect to the object within the predetermined color range (242). Therefore, in the aspect described above, it is possible to obtain a high-quality print image in accordance with the color of an object such as a character or a barcode.

### Aspect 5

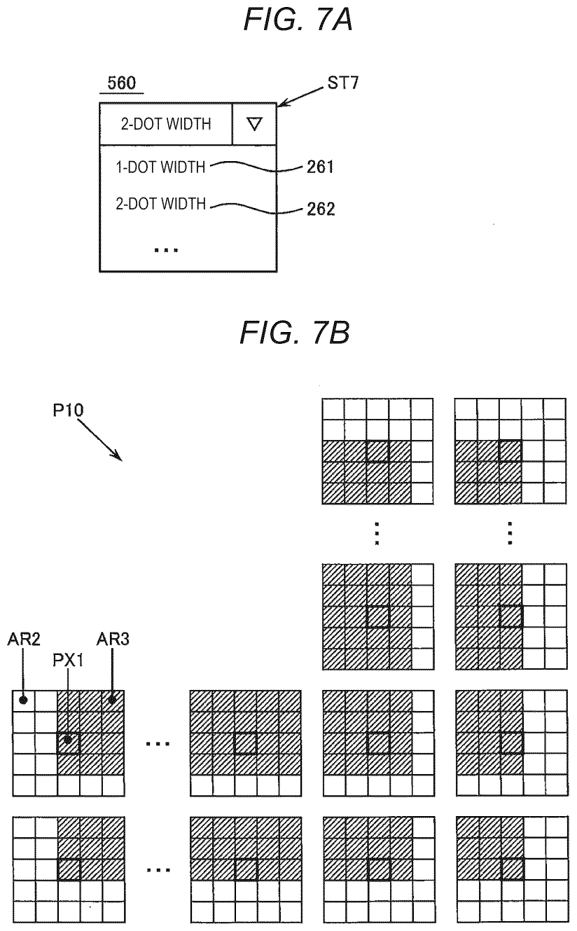

As illustrated in FIGS. 7A and 7B, the present method of generating the dot data may further include the following step.

(a8) An edge width designation step ST7 of receiving designation of a width of the first processing target edge portion E1.

In the first detection step ST1, the first processing target edge portion E1 may be detected so as to have the width designated.

In this case, the width of the first processing target edge portion E1 to be detected can be adjusted to the intention of the user. Therefore, in the aspect described above, it is possible to improve the image quality of the print image in accordance with the intention of the user.

### Aspect 6

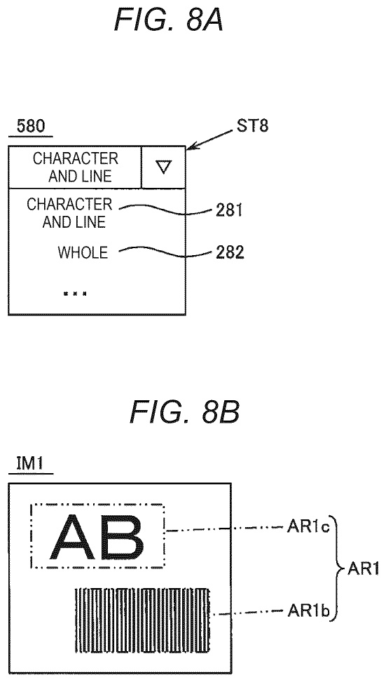

As illustrated in FIGS. 8A and 8B, the present method of generating the dot data may further include the following step.

(a9) An object designation step ST8 of designating an object (e.g., “CHARACTER AND LINE” item 281) belonging to the image IM1.

In the first detection step ST1, the first processing target edge portion E1 may be detected using an area (e.g., a character area AR1c and a line area AR1b) of the object (281) thus designated as the detection target area AR1.

In the above case, the detection target area AR1 can be adjusted to the intention of the user. Therefore, in the aspect described above, it is possible to improve the image quality of the print image in accordance with the intention of the user.

### Aspect 7

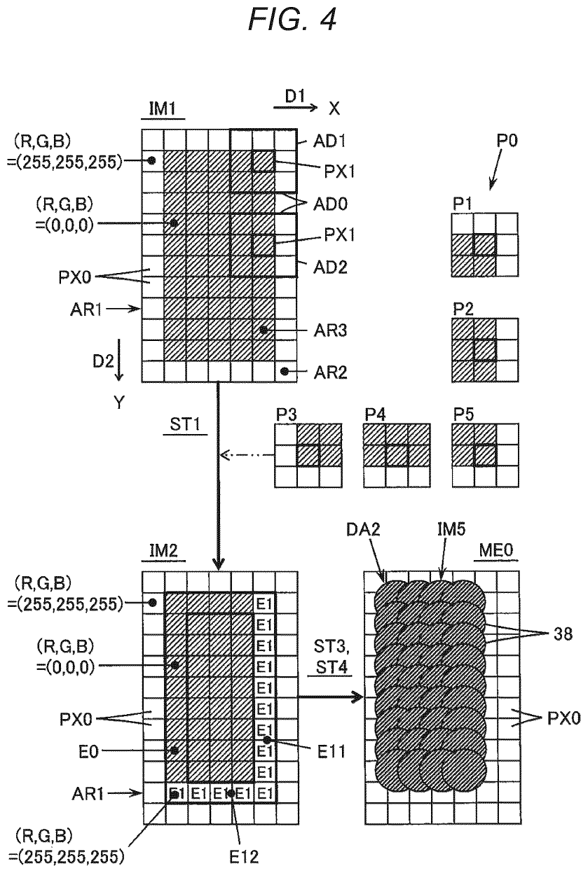

Incidentally, as illustrated in FIGS. 1 and 2, the printing apparatus 1 according to an aspect is the printing apparatus 1 configured to form the print image IM5 on a print medium ME0 with the ink 36, and includes the print head 30 and a control unit U1. The print head 30 is capable of ejecting the ink 36. The control unit U1 controls the ejection of the ink 36 from the print head 30 to the print medium ME0 such that the dots 38 forming the print image IM5 are formed on the print medium ME0. The control unit U1 performs the following processing as illustrated in FIGS. 3 and 4.

(b1) First detection processing (e.g., step S102 in FIG. 3) of detecting, as a first processing target edge portion E1, at least one of a first edge portion E11 located at one side in an area (AR3) darker than surrounding area (AR2) in a first direction D1 and a second edge portion E12 located at one side in an area (AR3) darker than a surrounding area (AR2) in a second direction D2 crossing the first direction D1 out of edges E0 existing in a detection target area AR1 as at least a part of an image IM1 including a plurality of pixels PX0 arranged in the first direction D1 and the second direction D2.

(b2) Ejection control processing (e.g., steps S108 to S114 in FIG. 3) of controlling the ejection of the ink 36 from the print head 30 to the print medium ME0 such that the amount of the ink 36 ejected to the first processing target edge portion E1 is reduced.

According to the aspect described above, it is possible to provide a printing apparatus capable of suppressing the degradation of the printing quality due to the bleeding of the ink while suppressing deterioration of thin lines due to the fact that the ink is not ejected over the entire edge. Further, the control unit U1 may perform at least some of second detection processing corresponding to the second detection step ST2, medium type designation processing corresponding to the medium type designation step ST5, color designation processing corresponding to the color designation step ST6, edge width designation processing corresponding to the edge width designation step ST7, and object designation processing corresponding to the object designation step ST8.

Further, the aspect described above can be applied to a printing method including the method of generating the dot data described above, a printing system including the printing apparatus described above, a method of controlling the printing apparatus described above, a control program of the printing apparatus described above, a non-transitory computer-readable medium on which the control program is recorded, and so on. In addition, the printing apparatus described above may be configured with a plurality of distributed portions.

### (2) Specific Example of Printing Apparatus

FIG. 1 schematically illustrates a configuration of the printing apparatus 1. The printing apparatus 1 of this specific example is the printer 2 itself, but the printing apparatus 1 may be a combination of the printer 2 and a host apparatus HO1. The host apparatus HO1 illustrated in FIG. 1 includes a display device DU1. The printer 2 illustrated in FIG. 1 is an inkjet printer that ejects the ink 36 as ink droplets 37 from the print head 30. The printer 2 may be a line printer in which the print head 30 does not move and the print medium ME0 moves in a feeding direction D3, or may be a serial printer or the like, and the printing apparatus 1 may include an additional element not illustrated in FIG. 1. FIG. 2 schematically illustrates a nozzle surface 30a of the print head 30.

The printer 2 forms the print image IM5 on the print medium ME0 with the ink 36 ejected from the print head 30. The printer 2 illustrated in FIG. 1 includes a controller 10, a random access memory (RAM) 21 that is a semiconductor memory, a communication interface (I/F) 22, a storage unit 23, an operation panel 24, the print head 30, a drive unit 50, and so on. The controller 10 and the drive unit 50 are an example of the control unit U1. The controller 10, the RAM 21, the communication I/F 22, the storage unit 23, and the operation panel 24 are coupled to a bus and can input and output information to and from each other.

The controller 10 includes a central processing unit (CPU) 11 as a processor, an edge correction unit 12, a color conversion unit 13, a halftone processing unit 14, a drive signal transmission unit 15, and so on. The controller 10 controls the drive unit 50 and the print head 30 so that the print image IM5 is formed on the print medium ME0 based on an image acquired from any of the host apparatus HO1, a memory card (not illustrated), and so on. As the image to be acquired, for example, an RGB image represented by RGB data having integer values of 2⁸ gray levels (2¹⁶ gray levels or the like) in R (red), G (green), and B (blue) for each pixel can be applied.

The controller 10 can be formed of a system on a chip (SoC) or the like.

The CPU 11 is a device that mainly performs information processing and control in the printer 2.

When the resolution of the acquired image is different from print resolution, the edge correction unit 12 may convert the resolution of the acquired image into the print resolution. The image resolution of which is adjusted to the print resolution is referred to as the image IM1. The edge correction unit 12 detects the processing target edge portions (E1, E2) from the image IM1 in units of pixels PX0 (see FIG. 4) to generate a corrected image IM3 in which the amount of the ink 36 ejected to the processing target edge portions (E1, E2) is reduced. Although described later in detail, the processing target edge portions (E1, E2) collectively refer to the first processing target edge portion E1 illustrated in FIG. 4 and the second processing target edge portion E2 illustrated in FIG. 5. When the image IM1 is an RGB image, the corrected image IM3 is also an RGB image. Further, the edge correction unit 12 may generate the corrected image IM3 before the resolution conversion and then convert the resolution of the corrected image IM3 into the print resolution.

The color conversion unit 13 refers to, for example, a color conversion lookup table (LUT), in which a correspondence relationship between gradation values of R, G, and B and gradation values of C (cyan), M (magenta), Y (yellow), and K (black) is defined, to convert the RGB data representing the corrected image IM3 into ink amount data DA1. The ink amount data DA1 has, for example, integer values of 2⁸ gray levels (or 2¹⁶ gray levels) of C, M, Y, and K for each pixel PX0. The ink amount data DA1 represents the usage amount of the ink 36 of C, M, Y, and K in units of the pixel PX0.

The halftone processing unit 14 reduces the number of gray levels of the gradation value by performing halftone processing with any one of a dither method, an error diffusion method, and the like on the gradation value of each pixel PX0 constituting the ink amount data DA1 to generate the dot data DA2. The dot data DA2 represents the formation state of the dot 38 with the ink droplet 37 in units of the pixel PX0, and represents the position of the dot 38 formed with the ink 36 from the print head 30. The dot data DA2 may be binary data representing the presence or absence of dot formation, or may be multi-valued data in three or more gray levels that can cope with dots different in size such as small, medium, and large dots.

The drive signal transmission unit 15 generates a drive signal SG1 from the dot data DA2 and outputs the drive signal SG1 to the drive circuit 31 of the print head 30. The drive signal SG1 corresponds to a voltage signal applied to a drive element 32 of the print head 30. For example, when the dot data DA2 represents “dot formation”, the drive signal transmission unit 15 outputs the drive signal SG1 for ejecting the ink droplet for dot formation. Further, when the dot data DA2 is data having three or more values, the drive signal transmission unit 15 outputs the drive signal SG1 for ejecting the ink droplet for the large dot when the dot data DA2 represents “large dot formation”, and outputs the drive signal SG1 for ejecting the ink droplet for the small dot when the dot data DA2 represents “small dot formation”.

Each of the units 11 to 15 may be configured with an application specific integrated circuit (ASIC), and may directly read data to be processed from the RAM 21 or directly write processed data into the RAM 21.

As illustrated in FIG. 2, the print head 30 has, on the nozzle surface 30a, a plurality of nozzle arrays 33 in which a plurality of nozzles 34 capable of ejecting the ink droplets 37 onto the print medium ME0 is arranged at intervals of a predetermined nozzle pitch in a nozzle arrangement direction D4. Here, the nozzle means a small opening through which ink droplets are jetted, and the nozzle array means an array of a plurality of nozzles. The nozzle surface 30a is an ejection surface of the ink droplets 37. The plurality of nozzles 34 of each nozzle array 33 may be arranged in a staggered manner in the nozzle arrangement direction D4, in other words, in two rows in the nozzle arrangement direction D4. The nozzle arrangement direction D4 may cross the feeding direction D3, or may cross a main scanning direction crossing the feeding direction D3 as in a serial printer or the like. The plurality of nozzle arrays 33 includes a C nozzle array 33C capable of ejecting the ink 36 in C, an M nozzle array 33M capable of ejecting the ink 36 in M, a Y nozzle array 33Y capable of ejecting the ink 36 in Y, and a K nozzle array 33K capable of ejecting the ink 36 in K. Each ink droplet 37 is ejected from the nozzle 34 to the print medium ME0 targeting the pixel PX0. Obviously, the dot 38 in C is formed on the print medium ME0 with the ink droplet 37 in C, the dot 38 in M is formed on the print medium ME0 with the ink droplet 37 in M, the dot 38 in Y is formed on the print medium ME0 with the ink droplet 37 in Y, and the dot 38 in K is formed on the print medium ME0 with the ink droplet 37 in K. The printer 2 may include a plurality of print heads 30.

The drive unit 50 controlled by the controller 10 feeds the print medium ME0 in the feeding direction D3 along a conveyance path 59 by driving the roller driver 55. The roller driver 55 includes a conveyance roller pair 56 and a discharge roller pair 57. The roller driver 55 is configured with a servomotor, and feeds the print medium ME0 in the feeding direction D3 by rotating a driving conveyance roller of the conveyance roller pair 56 and a driving discharge roller of the discharge roller pair 57 under the control of the controller 10. It can be said that the control unit U1 controls the relative positional relationship between the print head 30 and the print medium ME0.

The print medium ME0 is a print target object that holds a print image. The material of the print medium ME0 is not particularly limited, and various materials such as paper, resin, and metal are conceivable. The shape of the print medium ME0 is also not particularly limited, and various shapes such as a rectangular shape and a roll shape are conceivable, and may be a three-dimensional shape.

A platen 58 is located below the conveyance path 59 and supports the print medium ME0 by coming into contact with the print medium ME0 located in the conveyance path 59. The print head 30 controlled by the controller 10 includes a drive circuit 31, the drive element 32, and so on, and causes the ink 36 to adhere to the print medium ME0 by ejecting the ink droplets 37 toward the print medium ME0 supported by the platen 58. Therefore, it can be said that the control unit U1 controls the ejection of the ink droplets 37 from the print head 30.

The drive circuit 31 applies a voltage signal to the drive element 32 in accordance with the drive signal SG1 input from the drive signal transmission unit 15. The drive element 32 may be a piezoelectric element that applies pressure to the ink 36 located in a pressure chamber communicating with the nozzle 34, or may be a drive element or the like that generates bubbles in the pressure chamber with heat to eject the ink droplets 37 from the nozzle 34. The ink 36 is supplied to the pressure chamber of the print head 30 from an ink supply unit 35 such as an ink cartridge or an ink tank. The ink 36 located in the pressure chamber is ejected by the drive element 32 as the ink droplets 37 from the nozzle 34 toward the print medium ME0. As a result, the dots 38 of the ink droplets 37 are formed on the print medium ME0, and the print image IM5 expressed by the pattern of the dots 38 is formed on the print medium ME0. Therefore, it can be said that the control unit U1 controls the ejection of the ink 36 from the print head 30 to the print medium ME0 such that the dots 38 constituting the print image IM5 are formed on the print medium ME0.

The RAM 21 stores images and so on received from the host apparatus HO1, a memory (not illustrated), or the like. The communication I/F 22 is coupled to the host apparatus HO1 by wire or wirelessly and inputs and outputs information to and from the host apparatus HO1. The host apparatus HO1 includes a computer such as a personal computer or a tablet terminal, a mobile phone such as a smartphone, a digital camera, a digital video camera, and so on. The storage unit 23 may be a nonvolatile semiconductor memory such as a flash memory, or may be a magnetic storage device such as a hard disk, or the like. The operation panel 24 includes an output unit 25 such as a liquid crystal panel that displays information, an input unit 26 such as a touch panel that receives an operation on a display screen, and the like.

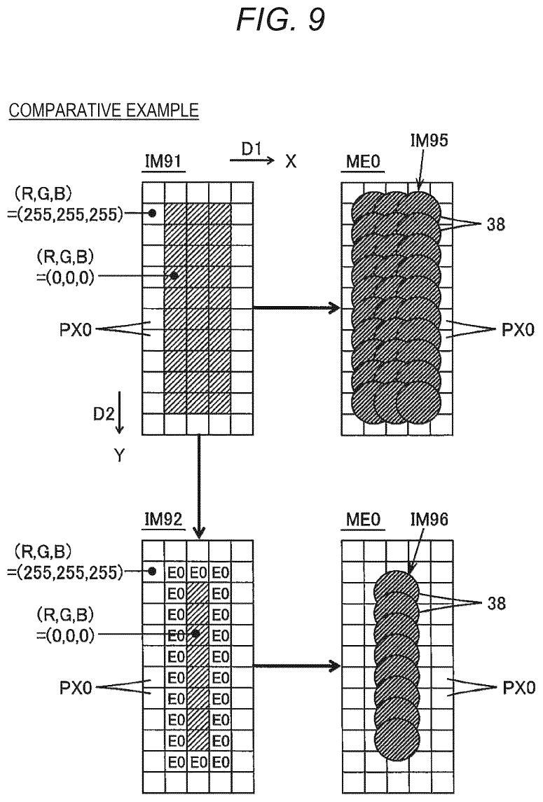

Incidentally, as illustrated in FIG. 9, it is conceivable that a dark area such as a black area surrounded by a white area becomes larger by the dot 38 derived from the ink droplet as a liquid spreading to be larger than the pixel PX0. In particular, by the ink droplets having landed on the print medium ME0 bleeding, a dark area may excessively expand to degrade the printing quality of characters or make the barcode out of the standard in some cases.

FIG. 9 schematically illustrates a comparative example in which print images (IM95, IM96) are formed from an input image IM91 as an RGB image. In the images (IM91, IM92) shown in FIG. 9, the pixels PX0 located in the black area are hatched. It is assumed that the gradation values (R, G, B) of the pixel PX0 in the white area are (255, 255, 255), and the gradation values (R, G, B) of the pixel PX0 in the black area are (0, 0, 0).

The input image IM91 illustrated in FIG. 9 includes a black line in which three pixels are arranged in the X direction as an example of the first direction D1. The black line extends in the Y direction as an example of the second direction D2 orthogonal to the first direction D1. When the dots 38 in K, for example, large dots are formed on the print medium ME0 based on the pixels PX0 of the black line, the print image IM95 having a black line wider than three pixels is formed on the print medium ME0 due to bleeding of ink droplets.

It is assumed that in order to prevent the degradation of the printing quality due to the bleeding of ink droplets, an edge E0 of a black area is detected and the ink droplets are not ejected over the entire edge E0. In the corrected image IM92 illustrated in FIG. 9, the pixel values of the edge E0 in the input image IM91 are changed from (0, 0, 0) to (255, 255, 255). As a result, the width of the black line decreases from three pixels to one pixel, and the print image IM96 having the black line with one dot row is formed on the print medium ME0. When the black line is a barcode, the barcode may become too thin to read in some cases. When the black line is an object including a thin line such as a character, the deterioration of the object is conspicuous.

In this specific example, there is adopted a rule that by limiting a region where the ink amount is reduced to a part of the edge portion, degradation of the printing quality due to bleeding of the ink is suppressed while suppressing deterioration of a thin line.

A specific example of print control processing for implementing the method of generating the dot data will hereinafter be described with reference to FIGS. 3 to 8B.

### (3) Specific Example of Print Control Processing

FIG. 3 schematically illustrates the print control processing performed by the controller 10. FIG. 4 schematically illustrates a state of forming the print image IM5 in which the ink amount in the first processing target edge portion E1 is reduced from the input image. It is assumed that the input image is an RGB image, and the images (IM1, IM2) shown in FIG. 4 are each an RGB image. In the images (IM1, IM2) shown in FIG. 4, the surrounding area AR2 is a white area in which the pixel values (R, G, B) are (255, 255, 255), and the dark area AR3 darker than the surrounding area AR2 is a black area in which the pixel values (R, G, B) are (0, 0, 0). FIG. 4 also shows a reference pattern P0 applied to the image IM1. In FIG. 4, pixels PX0 located in the dark area AR3 including the reference pattern P0 are hatched.

In FIG. 3, step S102 corresponds to the first detection step ST1 and the first detection processing. Step S106 corresponds to the second detection step ST2 and the second detection processing. Steps S108 to S112 correspond to the generation step ST3. Step S114 corresponds to the printing step ST4. Steps S108 to S114 correspond to the ejection control processing. Hereinafter, the description of “step” may be omitted, and the reference character of the step may be shown in a parenthesis.

When the print control processing shown in FIG. 3 starts, the controller 10 performs, in the edge correction unit 12, the first detection processing of detecting, as the first processing target edge portion E1, a part of the edge E0 from the image IM1 which is an RGB image (S102).

It is assumed that the image IM1 includes a plurality of pixels PX0 arranged in the X direction as an example of the first direction D1 and the Y direction as an example of the second direction D2 crossing the first direction D1 as illustrated in FIG. 4. The feeding direction D3 illustrated in FIGS. 1 and 2 may be the X direction or may be the Y direction. In FIG. 4, the X direction and the Y direction are orthogonal to each other. Note that the Y direction may be assumed as the first direction D1, and the X direction may be assumed as the second direction D2. In FIG. 4, the detection target area AR1 of the first processing target edge portion E1 is the entire image IM1. As shown in the extracted image IM2, the edge E0 existing in the detection target area AR1 is defined an area corresponding to one pixel adjacent in the X direction or the Y direction to the surrounding area AR2 in the dark area AR3.

Here, out of the edge portions located at the left side and the right side of the dark area AR3 in the X direction, the edge portion located at one side is defined as a first edge portion E11. Further, out of the edge portions located at the upper side and the lower side of the dark area AR3 in the Y direction, the edge portion located at one side is defined as a second edge portion E12. FIG. 4 shows that the first edge portion E11 is located at the right side in the dark area AR3 and the second edge portion E12 is located at the lower side in the dark area AR3. The first edge portion E11 may be located at the left side instead of the right side in the dark area AR3. That is, the first edge portions E11 do not exist at both sides of the dark area AR3 in the X direction. The second edge portion E12 may be located at the upper side instead of the lower side in the dark area AR3. That is, the second edge portions E12 do not exist at both sides of the dark area AR3 in the Y direction.

FIG. 4 illustrates that both the first edge portion E11 and the second edge portion E12 are detected as the first processing target edge portion E1. The controller 10 may detect the first edge portion E11 as the first processing target edge portion E1 without including the second edge portion E12, or may detect the second edge portion E12 as the first processing target edge portion E1 without including the first edge portion E11. When an area is longer in the Y direction than in the X direction as in the case of the dark area AR3 shown in FIG. 4, the first processing target edge portion E1 preferably includes the first edge portion E11.

The first processing target edge portion E1 can be detected by pattern matching using the reference pattern P0 shown in FIG. 4. Here, the pattern means a set of features such as signals and pictures, and a relationship between the features. The pattern matching means to compare a certain pattern and a plurality of patterns prepared in advance with each other based on a predetermined evaluation criterion. The pattern matching is not limited to a comparison between an image and an image as long as the state of a target pixel and the surrounding pixels can be compared between an image and a pattern based on an evaluation criterion such as a comparison between signals expressed by 0 and 1. The reference pattern P0 illustrated in FIG. 4 collectively refers to reference patterns P1 to P5 having a rectangular shape (including a square shape), and can also be referred to as a teacher image of the image IM1. The reference patterns P1 to P5 illustrated in FIG. 4 have a square shape of 3×3 pixels. For the sake of convenience of explanation, the pixel PX0 belonging to the surrounding area AR2 is referred to as a light pixel, and the pixel PX0 belonging to the dark area AR3 is referred to as a dark pixel. The light pixels shown in FIG. 4 are white pixels pixel values (R, G, B) of which are (255, 255, 255), and the pixel values of the light pixels in the reference patterns P1 to P5 also satisfy (R, G, B)=(255, 255, 255). The dark pixels shown in FIG. 4 are black pixels pixel values (R, G, B) of which are (0, 0, 0), and the pixel values of the dark pixels in the reference patterns P1 to P5 also satisfy (R, G, B)=(0, 0, 0).

Note that in addition to the reference patterns P1 to P5, the reference pattern P0 may include a reference pattern (not illustrated) that matches an oblique edge portions corresponding to the first edge portion E11 and the second edge portion E12, such as an oblique edge portion at the lower right side. Further, the size of the reference pattern may be 5×5 pixels, or may be a non-square size such as 3×5 pixels or 5×3 pixels.

The controller 10 sequentially sets the target pixel PX1 out of the plurality of pixels PX0 belonging to the image IM1, and performs pattern matching in which the reference pattern P0 is applied to the rectangular determination area AD0 centered on the target pixel PX1. The determination area AD0 has the same size as the reference patterns P1 to P5, and is an area of 3×3 pixels centered on the target pixel PX1 in the example illustrated in FIG. 4. When the arrangement of the light pixels and the dark pixels in the determination area AD0 matches the arrangement of the light pixels and the dark pixels in one of the reference patterns P1 to P5, the controller 10 detects the target pixel PX1 as the first processing target edge portion E1. When the pixel arrangement of the determination area AD0 does not match any of the pixel arrangements of the reference patterns P1 to P5, the target pixel PX1 is not the first processing target edge portion E1. For example, since the pixel arrangement of the determination area AD1 matches the pixel arrangement of the reference pattern P1, the target pixel PX1 in the determination area AD1 is detected as the first processing target edge portion E1. Since the pixel arrangement of the determination area AD2 matches the pixel arrangement of the reference pattern P2, the target pixel PX1 in the determination area AD2 is detected as the first processing target edge portion E1.

In this way, the controller 10 detects, as the first processing target edge portion E1, at least one of the first edge portion E11 located at one side in the dark area AR3 in the first direction D1 and the second edge portion E12 located at one side in the dark area AR3 in the second direction D2 out of the edges E0 existing in the detection target area AR1.

After the processing in S102 in FIG. 3, the controller 10 branches the processing in accordance with whether the edge correction unit 12 detects an edge existing in the extracted image IM2 representing a portion other than the first processing target edge portion E1 as the second processing target edge portion E2 in the detection target area AR1 (S104). The controller 10 performs the second detection processing in S106 when the second processing target edge portion E2 is detected in the edge correction unit 12, or skips S106 to advances the process to S108 when the second processing target edge portion E2 is not detected in the edge correction unit 12. The second detection processing in S106 will be described later.

In S108, the controller 10 performs, in the edge correction unit 12, correction of reducing the ink amount in the processing target edge portions (E1, E2). As a result, it can be said that the processing in S108 is processing of thinning or reducing the size of dots 38 in the processing target edge portions (E1, E2). When the second processing target edge portion E2 is not detected, the controller 10 performs correction of reducing the ink amount only in the first processing target edge portion E1. When the first processing target edge portion E1 is detected as shown in FIG. 4, the controller 10 generates the dot data DA2 from the image IM1 so that the ink 36 is not ejected from the print head 30 to the first processing target edge portion E1. For example, the controller 10 generates the extracted image IM2 by changing the pixel values (R, G, B) of the first processing target edge portion E1 out of the image IM1 from (0, 0, 0) to (255, 255, 255). Note that the ink amount of the first processing target edge portion E1 may be reduced to, for example, 1 to 50 % with reference to that before the correction. For example, the pixel values (R, G, B) of the first processing target edge portion E1 may be replaced with (128, 128, 128) which are each an ink amount of about 50 % with reference to that before the correction. Note that the pixel values shown in the present specification are merely examples for explaining the present specific example in an easy-to-understand manner, and can variously be changed. The same applies to the following. When the second detection processing in S106 is not performed, the controller 10 performs the processing in S110 and subsequent steps using the extracted image IM2 described above as the corrected image IM3.

After the processing in S108, the controller 10 performs, in the color conversion unit 13, color conversion processing of converting the corrected image IM3 into the ink amount data DA1 (S110). When the pixel values (R, G, B) of the corrected image IM3, which is an RGB image, are (255, 255, 255), the pixel values of the pixel PX0 of the first processing target edge portion E1 are converted into pixel values with which the ink droplet 37 is not ejected, such as (C, M, Y, K)=(0, 0, 0, 0). After the color conversion processing, the controller 10 performs, in the halftone processing unit 14, halftone processing of converting the ink amount data DA1 into the dot data DA2 (S112). When the pixel values (C, M, Y, K) of the ink amount data DA1 are (0, 0, 0, 0), the pixel values of the pixel PX0 of the first processing target edge portion E1 are converted into a value representing absence of the dot such as 0 in all of C, M, Y, and K. The dot data DA2 for forming the dots 38 such as large dots in the dark pixels of the corrected image IM3 is schematically illustrated in the print medium ME0 shown in FIG. 4.

In this way, the controller 10 generates the dot data DA2 from the image IM1 so that the amount of the ink 36 to be ejected from the print head 30 to the first processing target edge portion E1 is reduced to a value including 0. Note that in the present specification, “so that the amount of the ink 36 to be ejected to the first processing target edge portion E1 is reduced to a value including 0” is intended “to reduce the amount of the ink to be ejected” with reference to when the correction is not performed, or “to stop the ejection”.

After the halftone processing, the controller 10 generates the drive signal SG1 based on the dot data DA2, and then transmits the drive signal SG1 to the drive circuit 31 of the print head 30 (S114), to end the print control processing. The print head 30 ejects the ink droplets 37 in K so that a plurality of dots 38 is formed in the dark pixels as illustrated in the print medium ME0 in FIG. 4 in accordance with the drive signal SG1. As a result, the print image IM5 expressed by the pattern of the dots 38 is formed on the print medium ME0. It can be said that the printer 2 ejects the ink 36 from the print head 30 onto the print medium ME0 based on the dot data DA2.

As described hereinabove, the amount of the ink 36 ejected not to the whole of the edge E0 existing in the detection target area AR1 but to at least one of the edge portions (E11 and E12) located at one sides in the dark area AR3 is reduced. Accordingly, it becomes possible to avoid the disadvantage that an object such as a barcode or a fine character becomes too thin while obtaining an effect of suppressing the degradation of the printing quality due to the bleeding of the ink 36.

It is conceivable that when the ink 36 having landed on the print medium ME0 is easy to bleed, the bleeding of the ink 36 becomes conspicuous even when a portion to which the ink 36 is not ejected is limited to the first processing target edge portion E1 out of the edges E0 existing in the detection target area AR1. In this case, by performing the second detection processing in S106 illustrated in FIG. 3, it becomes possible to suppress the bleeding of the ink 36 while leaving the thin line. Therefore, the second detection processing in S106 in FIG. 3 will be described with reference to FIG. 5.

FIG. 5 schematically illustrates a state in which the dot data DA2 in which the ink amount in the second processing target edge portion E2 is reduced is generated from the extracted image IM2. In the images (IM2, IM3) shown in FIG. 5, the surrounding area AR2 is a white area where the pixel values (R, G, B) are (255, 255, 255), and the pixels PX0 hatched are a black area where the pixel values (R, G, B) are (0, 0, 0).

In S106 illustrated in FIG. 3, the controller 10 performs, in the edge correction unit 12, the second detection processing of detecting, as the second processing target edge portion E2, an edge existing in the extracted image IM2 representing a portion other than the first processing target edge portion E1 in the detection target area AR1. As illustrated in the corrected image IM3, the second processing target edge portion E2 illustrated in FIG. 5 is the whole of an edge of a portion of the dark area AR3 other than the first processing target edge portion E1. Note that the controller 10 may detect, as the second processing target edge portion E2, only a part of the edge of a portion of the dark area AR3 other than the first processing target edge portion E1. For example, the controller 10 can detect the second processing target edge portion E2 by pattern matching using a reference pattern capable of detecting the whole or a part of the edge of the extracted image IM2. The pattern matching is particularly effective when detecting, as the second processing target edge portion E2, an edge portion existing at one side in the first direction D1 in the dark area other than the first processing target edge portion E1, or an edge portion existing at one side in the second direction D2 in the dark area other than the first processing target edge portion E1. Further, the controller 10 may detect the second processing target edge portion E2 by a filter calculation using a known edge detection filter. A Laplacian filter or the like can be used as an edge detection filter for detecting the entire edge.

After the second detection processing, the controller 10 performs, in the edge correction unit 12, correction to reduce the ink amounts in both the first processing target edge portion E1 and the second processing target edge portion E2 (S108). The controller 10 in the present specific example generates the dot data DA2 from the image IM1 so that the ink 36 is not ejected from the print head 30 to the first processing target edge portion E1 and the amount of the ink 36 ejected from the print head 30 to the second processing target edge portion E2 is reduced within a range in which that amount does not become 0. For example, the controller 10 generates the extracted image IM2 by changing the pixel values (R, G, B) of the first processing target edge portion E1 out of the image IM1 from (0, 0, 0) to (255, 255, 255). In addition, the controller 10 generates the corrected image IM3 by changing the pixel values such that the ink amount in the second processing target edge portion E2 out of the extracted image IM2 becomes, for example, 1 to 50% with reference to the ink amount before the correction. For example, the pixel values (R, G, B) of the second processing target edge portion E2 may be replaced with (128, 128, 128), corresponding to an ink amount of about 50% with reference to the amount before the correction.

After the processing in S108, the controller 10 performs, in the color conversion unit 13, color conversion processing of converting the corrected image IM3 into the ink amount data DA1 (S110). When the pixel values (R, G, B) of the corrected image IM3, which is an RGB image, are (255, 255, 255), the pixel values of the pixel PX0 of the first processing target edge portion E1 are converted into pixel values with which the ink droplet 37 is not ejected, such as (C, M, Y, K)=(0, 0, 0, 0). When the pixel values (R, G, B) of the corrected image IM3 are (128, 128, 128), the pixel values of the pixel PX0 of the second processing target edge portion E2 are converted from the pixel values with which the size of the ink droplet 37 in K corresponds to a large dot into the pixel values with which the size of the ink droplet 37 in K is reduced to a size corresponding to a medium dot, for example, (C, M, Y, K)=(0, 0, 0, 127). After the color conversion processing, the controller 10 performs, in the halftone processing unit 14, halftone processing of converting the ink amount data DA1 into the dot data DA2 (S112). When the pixel values (C, M, Y, K) of the ink amount data DA1 are (0, 0, 0, 0), the pixel values of the pixel PX0 of the first processing target edge portion E1 are converted into a value representing absence of the dot such as 0 in all of C, M, Y, and K. The dark pixel in the corrected image IM3 is converted into a value representing a large dot in K, for example, 3. When the pixel values (C, M, Y, K) of the ink amount data DA1 are (0, 0, 0, 127), the pixel values of the pixel PX0 of the second processing target edge portion E2 are converted so that the pixel value for K represents a medium dot, for example, 2.

After the halftone processing, the controller 10 generates the drive signal SG1 based on the dot data DA2, and then transmits the drive signal SG1 to the drive circuit 31 of the print head 30 (S114), to end the print control processing. As a result, the print image IM5 expressed by the pattern of the dots 38 corresponding to the pixel values of the dot data DA2 shown in FIG. 5 is formed on the print medium ME0.

As described above, when the bleeding of the ink 36 is conspicuous only by setting the ink amount in the first processing target edge portion E1 to 0, the bleeding of the ink 36 is suppressed by reducing the amount of the ink 36 ejected to the second processing target edge portion E2 within a range in which that amount does not become 0. Therefore, when the ink 36 having landed on the print medium ME0 is easy to bleed, it is possible to suppress the bleeding of the ink 36 while leaving the thin line.

Note that a part of the processing described above may be performed by the host apparatus HO1. In this case, a combination of the controller 10, the drive unit 50, and the host apparatus HO1 is an example of the control unit U1, and a combination of the printer 2 and the host apparatus HO1 is an example of the printing apparatus 1. The subject that performs the processing described above is not limited to the CPU, and may be an electronic component other than the CPU, such as an ASIC. Obviously, a plurality of CPUs may cooperate with each other to perform the processing described above, or the CPU and other electronic components (e.g., an ASIC) may cooperate with each other to perform the processing described above.

For the determination processing in S104 illustrated in FIG. 3, the printing apparatus 1 can display screens (500, 520) illustrated in FIGS. 6A and 6B on at least one of the output unit 25 of the operation panel 24 and the display device DU1 of the host apparatus HO1. FIG. 6A schematically illustrates a display example of an edge detection processing designation screen 500.

The edge detection processing designation screen 500 illustrated in FIG. 6A includes an “ONLY ONCE” item 201, a “TWO-STAGE PROCESSING” item 202, and so on. In S104 illustrated in FIG. 3, for example, the controller 10 causes the output unit 25 to display the edge detection processing designation screen 500, and receives designation of any one of the plurality of options (201, 202) in the input unit 26 of the operation panel 24. The controller 10 determines that the condition is not satisfied and proceeds to S108 when the designation of the “ONLY ONCE” item 201 is received, and determines that the condition is satisfied and proceeds to S106 when the designation of the “TWO-STAGE PROCESSING” item 202 is received. When the host apparatus HO1 performs the processing in S102 to S108, the host apparatus HO1 causes the display device DU1 to display the edge detection processing designation screen 500, and receives designation of any one of the plurality of options (201, 202) in an input unit (not illustrated). The host apparatus HO1 determines that the condition is not satisfied and proceeds to S108 when the designation of the “ONLY ONCE” item 201 is received, and determines that the condition is satisfied and proceeds to S106 when the designation of the “TWO-STAGE PROCESSING” item 202 is received.

In this way, when the “ONLY ONCE” item 201 is designated, the printing apparatus 1 does not detect the second processing target edge portion E2 and generates the dot data DA2 from the image IM1 so that the amount of the ink 36 ejected from the print head 30 to the first processing target edge portion E1 is reduced. When the “TWO-STAGE PROCESSING” item 202 is designated, the printing apparatus 1 generates the dot data DA2 from the image IM1 so that the amount of the ink 36 ejected to both the processing target edge portions (E1, E2) is reduced.

FIG. 6B schematically illustrates a display example of the medium type designation screen 520.

The medium type designation screen 520 illustrated in FIG. 6B includes a plurality of types 220 usable as the print medium ME0, such as a “PHOTO PAPER” item as an example of the first type 221 and a “PLAIN PAPER” item as an example of the second type 222. Since the ink 36 is easier to bleed in plain paper than in photo paper (an example of glossy paper), it can be said that the ink 36 is more likely to bleed in the second type 222 than in the first type 221. As the second type 222 in which the ink 36 is easy to bleed, fabric or the like is also considered. In S104 illustrated in FIG. 3, for example, the controller 10 causes the output unit 25 to display the medium type designation screen 520, and receives designation of a type to be used out of a plurality of types (221, 222) in the input unit 26 of the operation panel 24. The controller 10 determines that the condition is not satisfied and proceeds to S108 when the designation of the first type 221 is received, and determines that the condition is satisfied and proceeds to S106 when the designation of the second type 222 is received. Obviously, the host apparatus HO1 may perform the processing in S102 to S108. In any case, the medium type designation step ST5 of receiving designation of a type to be used from the plurality of types 220 is executed in S104. When the second type 222 is designated, the second detection step ST2 (see FIGS. 3 and 5) of detecting, as the second processing target edge portion E2, an edge located in the extracted image IM2 representing a portion other than the first processing target edge portion E1 in the detection target area AR1 is executed in S106. In S108, the ink amount in the first processing target edge portion E1 is corrected to 0, and the ink amount in the second processing target edge portion E2 is reduced within a range in which that amount does not become 0.

In this way, when the first type 221 is designated, the printing apparatus 1 does not detect the second processing target edge portion E2 and generates the dot data DA2 from the image IM1 so that the ink 36 is not ejected from the print head 30 to the first processing target edge portion E1. When the second type 222 is designated, the printing apparatus 1 generates the dot data DA2 from the image IM1 such that the ink 36 is not ejected from the print head 30 to the first processing target edge portion E1 and the amount of the ink 36 ejected from the print head 30 to the second processing target edge portion E2 is reduced within a range in which that amount does not become 0.

In the example shown in FIG. 6B, when the second type 222 in which the ink 36 is easy to bleed is designated as the print medium ME0 to be used, it is possible to suppress the bleeding of the ink 36 while leaving the thin line. On the other hand, when the first type 221 in which the bleeding of the ink 36 is small is designated as the print medium ME0 to be used, the amount of the ink 36 ejected to the pixel PX0 that can be the second processing target edge portion E2 is maintained, and thus, the edge existing in the extracted image IM2 is clearly displayed. Therefore, the image quality of the print image is improved in accordance with the intention of the user.

Further, in order to switch the definition of the dark area AR3 in the print control processing illustrated in FIG. 3, the printing apparatus 1 can display a dark area designation screen 540 illustrated in FIG. 6C on at least one of the output unit 25 of the operation panel 24 and the display device DU1 of the host apparatus HO1. FIG. 6C schematically illustrates a display example of the dark area designation screen 540.

The dark area designation screen 540 illustrated in FIG. 6C includes a plurality of options 240 to be applied to the dark area AR3, such as a “BLACK ONLY” item 241 and a “OTHER THAN WHITE” item 242. The “BLACK ONLY” item 241 is an option for applying black of (R, G, B)=(0, 0, 0) as an example of the predetermined color to the dark area AR3. The “OTHER THAN WHITE” item 242 is an option for applying a color range other than white as an example of a predetermined color range to the dark area AR3. For example, the controller 10 makes the output unit 25 display the dark area designation screen 540, and then receives designation of any one of the plurality of options (241, 242) in the input unit 26 of the operation panel 24. When the designation of the “BLACK ONLY” item 241 is received, the controller 10 applies black with the pixel values (R, G, B)=(0, 0, 0) to the dark area AR3 in the images (IM1 to IM3) and the reference pattern P0 to perform the print control processing of FIG. 3. When the designation of the “OTHER THAN WHITE” item 242 is received, the controller 10 applies all colors whose pixel values (R, G, B) are not (255, 255, 255) to the dark area AR3 in the images (IM1 to IM3) and the reference pattern P0 to perform the print control processing of FIG. 3. Obviously, the host apparatus HO1 may cause the display device DU1 to display the dark area designation screen 540, and then receive, in the input unit (not illustrated), designation of any one of the plurality of options 240. In any case, the color designation step ST6 of receiving designation of an option to be applied to the dark area AR3 out of the plurality of options 240 including the “BLACK ONLY” item 241 and the “OTHER THAN WHITE” item 242 is performed.

When the “BLACK ONLY” item 241 is designated, the printing apparatus 1 treats the pixel PX0 having the pixel values (R, G, B)=(0, 0, 0) as the dark area AR3 in the images (IM1 to IM3) and the reference pattern P0 to perform the print control processing shown in FIG. 3. For example, the controller 10 detects, as the first processing target edge portion E1, the target pixel PX1 having the arrangement of the surrounding area AR2 with the pixel values (R, G, B)=(255, 255, 255) and the dark area AR3 with the pixel values (R, G, B)=(0, 0, 0) matching the arrangement of any one of the reference patterns P1 to P5 in the image IM1. It can be said that when a predetermined color is designated, the control unit U1 detects, as the first processing target edge portion E1, at least one of the first edge portion E11 located at one side in the first direction D1 in the dark area AR3 having the predetermined color and the second edge portion E12 located at one side in the second direction D2 in the dark area AR3 having the predetermined color out of the edges E0 existing in the detection target area AR1.

When the “OTHER THAN WHITE” item 242 is designated, the printing apparatus 1 treats the pixel PX0 having the pixel values (R, G, B) other than (255, 255, 255) as the dark area AR3 to perform the print control processing shown in FIG. 3. For example, the controller 10 detects, as the first processing target edge portion E1, the target pixel PX1 having the arrangement of the surrounding area AR2 with the pixel values (R, G, B)=(255, 255, 255) and the dark area AR3 with the pixel values other than (R, G, B)=(255, 255, 255) matching the arrangement of any one of the reference patterns P1 to P5 in the image IM1. It can be said that when a predetermined color range is designated, the control unit U1 detects, as the first processing target edge portion E1, at least one of the first edge portion E11 located at one side in the first direction D1 in the dark area AR3 in the predetermined color range and the second edge portion E12 located at one side in the second direction D2 in the dark area AR3 in the predetermined color range out of the edges E0 existing in the detection target area AR1.

For example, when an object such as a character or a barcode is black and the “BLACK ONLY” item 241 is designated, a high-quality print image IM5 is obtained by reducing the ink amount in the processing target edge portions (E1, E2) with respect to the object in black. For example, it is assumed that it is difficult to add information such as “character” to the image IM1 while it is desired to reduce the ink amount in an edge portion such as a character. In this case, by setting only black, which is often used as a character or the like, as a target for reducing the ink amount, it is possible to extract the pixel PX0 in which the ink amount is to be reduced from the original image IM1 to reduce the ink amount in that pixel PX0 without requiring complicated processing for generating the dot data DA2. Further, when the object has a color other than white and the “OTHER THAN WHITE” item 242 is designated, even when the object is not black, a high-quality print image IM5 can be obtained by reducing the ink amount in the processing target edge portions (E1, E2) with respect to the object having the color other than white. Therefore, a high-quality print image IM5 can be obtained in accordance with the color of an object such as a character or a barcode.

Note that even when an object such as a character or a barcode has a color other than black such as blue or red, the print control processing of FIG. 3 may be performed taking that color as a predetermined color included in the plurality of options 240.

Further, the surrounding area AR2 is not limited to the white area having the pixel values (R, G, B)=(255, 255, 255). For example, denoting an integer value larger than 128 and smaller than 255 by GR, the surrounding area AR2 may be an area of the pixels PX0 in a light color satisfying R≥GR, G≥GR, and B≥GR. In this case, the dark area AR3 is an area in a dark color satisfying R≤GR-1, G≤GR-1, or B≤GR-1. The predetermined color range included in the plurality of options 240 may be a color range satisfying R≤GR-1, G≤GR-1, or B≤GR-1.

Further, in order to switch the width of the processing target edge portions (E1, E2) in the print control processing illustrated in FIG. 3, the printing apparatus 1 can display an edge width designation screen 560 illustrated in FIG. 7A on at least one of the output unit 25 of the operation panel 24 and the display device DU1 of the host apparatus HO1. FIG. 7A schematically illustrates a display example of the edge width designation screen 560. FIG. 7B schematically illustrates a reference pattern P10 of 5×5 pixels. For the sake of convenience, the target pixel PX1, the surrounding area AR2, and the dark area AR3 are added to the reference pattern P10.

The edge width designation screen 560 illustrated in FIG. 7A includes a plurality of options for designating the width of the first processing target edge portion E1, such as a “1-DOT WIDTH” item 261 and a “2-DOT WIDTH” item 262. The “1-DOT WIDTH” item 261 is an option for setting the width of the first processing target edge portion E1 to one dot. The “2-DOT WIDTH” item 262 is an option for setting the width of the first processing target edge portion E1 to two dots. For example, the controller 10 causes the output unit 25 to display the edge width designation screen 560, and receives, in the input unit 26 of the operation panel 24, designation of any one of the plurality of options (261, 262). When the designation of the “1-DOT WIDTH” item 261 is received, the controller 10 detects the first processing target edge portion E1 from the image IM1 by pattern matching using the reference pattern P0 of 3×3 pixels shown in FIG. 4 in the first detection processing in S102 shown in FIG. 3. When the designation of the “2-DOT WIDTH” item 262 is received, the controller 10 detects the first processing target edge portion E1 from the image IM1 by pattern matching using the reference pattern P10 of 5×5 pixels shown in FIG. 7B in the first detection processing in S102 shown in FIG. 3. Obviously, the host apparatus HO1 may cause the display device DU1 to display the edge width designation screen 560, and receive, in the input unit (not illustrated), designation of any one of the plurality of options (261, 262). In any case, the edge width designation step ST7 of receiving the designation of the width of the first processing target edge portion E1 is executed. The controller 10 or the host apparatus HO1 performs a first detection processing of detecting the first processing target edge portion E1 so as to have the width designated.

The reference pattern P10 of 5×5 pixels illustrated in FIG. 7B collectively refers to a plurality of individual reference patterns different in the arrangement of light pixels and dark pixels from each other. For example, the controller 10 can sequentially set the target pixel PX1 from the image IM1 to perform the pattern matching in which the reference pattern P10 is applied to the determination area AD0 of 5×5 pixels centered on that target pixel PX1. Due to the reference pattern P10 of 5×5 pixels, not only a pixel adjacent to the surrounding area AR2 in the dark area AR3 but also a pixel at a distance of one pixel from the surrounding area AR2 in the first direction D1 or the second direction D2 can be the first processing target edge portion E1.

In this way, the width of the first processing target edge portion E1 to be detected can be adjusted to the intention of the user. Therefore, the image quality of the print image is improved in accordance with the intention of the user.

Note that for the second processing target edge portion E2, the designation of the width can be received by displaying a screen similar to the edge width designation screen 560. In this case, the controller 10 or the host apparatus HO1 may perform the second detection processing of detecting the second processing target edge portion E2 so as to have the width thus designated.

Further, in order to switch the detection target area AR1 in the print control processing illustrated in FIG. 3, the printing apparatus 1 can display an object designation screen 580 illustrated in FIG. 8A on at least one of the output unit 25 of the operation panel 24 and the display device DU1 of the host apparatus HO1. FIG. 8A schematically illustrates a display example of the object designation screen 580. FIG. 8B schematically illustrates the detection target area AR1 belonging to the image IM1.

The object designation screen 580 illustrated in FIG. 8A includes a plurality of options for designating the detection target area AR1, such as a “CHARACTER AND LINE” item 281 and a “WHOLE” item 282. The “CHARACTER AND LINE” item 281 is an option for setting the detection target area AR1 to a character and a line (including a barcode). A characters and a line are examples of objects belonging to the image IM1. The “WHOLE” item 282 is an option for setting the detection target area AR1 to the whole of the image IM1. For example, the controller 10 causes the output unit 25 to display the object designation screen 580, and receives, in the input unit 26 of the operation panel 24, designation of any one of the plurality of options (281, 282). When the designation of the “CHARACTER AND LINE” item 281 is received, as illustrated in FIG. 8B, the controller 10 extracts the character area AR1c and the line area AR1b from the image IM1 as the detection target area AR1. Information representing the positions of characters and lines is often associated with the image IM1. For example, when the image IM1 is derived from an image file having the information representing attributes of characters and lines, the controller 10 may acquire the information representing positions of characters and lines derived from the image file from the host apparatus HO1 or the like. When the designation of the “WHOLE” item 282 is received, the controller 10 treats the whole of the image IM1 as the detection target area AR1. Obviously, the host apparatus HO1 may cause the display device DU1 to display the object designation screen 580, and receive, in the input unit (not illustrated), designation of any one of the plurality of options (281, 282). In either case, the object designation step ST8 of designating an object belonging to the image IM1 is performed. The controller 10 or the host apparatus HO1 performs the first detection processing of detecting the first processing target edge portion E1 taking the areas (AR1c, AR1b) of the designated object as the detection target area AR1.

In this way, the detection target area AR1 can be adjusted to the intention of the user. Therefore, the image quality of the print image is improved in accordance with the intention of the user. In particular, a character or a line (including a barcode) has a large effect of reducing the ink amount in the processing target edge portions (E1, E2) described above.

Note that the object may be either one of a character and a line.

### (4) Modified Examples

Various Modified Examples of the Present disclosure are conceivable.

For example, the combination of ink colors is not limited to C, M, Y, and K, and may include orange, green, light cyan lower in density than C, light magenta lower in density than M, dark yellow higher in density than Y, and light black lower in density than K. Obviously, the aspects of the present disclosure can also be applied to when the printing apparatus 1 does not use any of the C ink, the M ink, the Y ink, and the K ink.

The detection of the first processing target edge portion E1 is not limited to the pattern matching. For example, the printing apparatus 1 may detect, as the first edge portion E11, the target pixel whose filter calculation value using a horizontal Sobel filter is larger or smaller than a predetermined threshold value in the dark area AR3. In addition, the printing apparatus 1 may detect, as the second edge portion E12, the target pixel whose filter calculation value using the vertical Sobel filter is larger or smaller than a predetermined threshold value in the dark area AR3. Further, the printing apparatus 1 may detect the whole of the edge E0 by a filter calculation using a Laplacian filter in the dark area AR3, and then detect the first processing target edge portion E1 based on the position of the light pixel adjacent to the dark pixel located at the edge E0.

In the specific example described above, the processing target edge portion is detected from the RGB image to reduce the ink amount in the processing target edge portion, but this is not a limitation. For example, the control unit may detect the processing target edge portion from a CMYK image expressed by the ink amount data to reduce the ink amount in the processing target edge portion. Further, the control unit may generate the corrected dot data by detecting the processing target edge portion from the dot image expressed by the dot data before the correction to thin or reduce the size of the dots in the processing target edge portion.

### (5) Conclusions

As described above, according to the present disclosure, it is possible to provide a configuration and so on capable of suppressing the degradation of the printing quality due to the bleeding of the ink while suppressing deterioration of thin lines due to the fact that the ink is not ejected over the entire edge with various aspects. Obviously, the basic functions and advantages described above can be provided even in an aspect including only the elements according to the independent claims.

In addition, it is conceivable to employ a configuration in which the elements disclosed in the examples described above are interchanged with each other or the combination of the elements is changed, a configuration in which the elements disclosed in known technologies and the examples described above are interchanged with each other or the combination of the elements is changed, and the like. The present disclosure also includes the configurations described above and the like.

What is claimed is:

1. A method of generating dot data representing positions of dots formed of ink from a print head, the method comprising:
a first detection step of detecting, as a first processing target edge portion, at least one of a first edge portion located at one side in a first direction in an area darker than a surrounding area and a second edge portion located at one side in a second direction crossing the first direction in an area darker than a surrounding area out of edges existing in a detection target area in at least a part of an image having a plurality of pixels arranged in the first direction and the second direction; and
a generation step of generating the dot data from the image such that an amount of the ink ejected from the print head to the first processing target edge portion is reduced.

2. The method of generating the dot data according to claim 1, further comprising
a second detection step of detecting, as a second processing target edge portion, at least a part of an edge existing in an extracted image representing a portion other than the first processing target edge portion in the detection target area, wherein
in the generation step, the dot data is generated from the image such that the ink is not ejected from the print head to the first processing target edge portion, and an amount of the ink ejected from the print head to the second processing target edge portion is reduced within a range in which the amount is not zero.

3. The method of generating the dot data according to claim 1, further comprising:
a printing step of ejecting the ink from the print head to a print medium based on the dot data;
a medium type designation step of receiving designation of a type of the print medium to be used out of a plurality of types of print media that are usable as the print medium, and include a first type and a second type in which the ink is easier to bleed than in the first type; and
a second detection step of detecting, as a second processing target edge portion, an edge existing in an extracted image representing a portion other than the first processing target edge portion in the detection target area when the second type is designated, wherein
in the generation step,
when the first type is designated, the dot data is generated from the image so that the ink is not ejected from the print head to the first processing target edge portion, and
when the second type is designated, the dot data is generated from the image so that the ink is not ejected from the print head to the first processing target edge portion, and an amount of the ink to be ejected from the print head to the second processing target edge portion is reduced within a range in which the amount is not zero.

4. The method of generating the dot data according to claim 1, further comprising
a color designation step of receiving designation of an option to be applied to the dark area out of a plurality of options including a predetermined color and a predetermined color range, wherein
in the first detection step,
when the predetermined color is designated, at least one of the first edge portion located at one side in the first direction in the dark area having the predetermined color and the second edge portion located at one side in the second direction in the dark area having the predetermined color is detected as the first processing target edge portion out of the edges existing in the detection target area, and
when the predetermined color range is designated, at least one of the first edge portion located at one side in the first direction in the dark area in the predetermined color range and the second edge portion located at one side in the second direction in the dark area in the predetermined color range is detected as the first processing target edge portion out of the edges existing in the detection target area.

5. The method of generating the dot data according to claim 1, further comprising
an edge width designation step of receiving designation of a width of the first processing target edge portion, wherein
in the first detection step, the first processing target edge portion is detected so as to have the width designated.

6. The method of generating the dot data according to claim 1, further comprising
an object designation step of designating an object that belongs to the image, wherein
in the first detection step, the first processing target edge portion is detected taking an area of the object designated as the detection target area.

7. A printing apparatus configured to form a print image on a print medium with ink, the apparatus comprising:
a print head configured to eject the ink; and
a control unit configured to control ejection of the ink from the print head to the print medium such that dots constituting the print image are formed on the print medium, wherein
the control unit is configured to perform
first detection processing of detecting, as a first processing target edge portion, at least one of a first edge portion located at one side in a first direction in an area darker than a surrounding area and a second edge portion located at one side in a second direction crossing the first direction in an area darker than a surrounding area out of edges existing in a detection target area in at least a part of an image having a plurality of pixels arranged in the first direction and the second direction, and
ejection control processing of controlling ejection of the ink from the print head to the print medium such that an amount of the ink to be ejected to the first processing target edge portion is reduced.
